(19) United States
(12) Patent Application Publication
(10) Pub. No.: US 2019/0196416 A1
(43) Pub. Date: Jun. 27, 2019

(54) System and Method for Hazardous Accident Detection and Remediation in a Facility

(71) Applicant: Walmart Apollo, LLC, Bentonville, AR (US)

(72) Inventor: Andrew B. Millhouse, Gilbert, AZ (US)

(21) Appl. No.: 16/227,222

(22) Filed: Dec. 20, 2018

Related U.S. Application Data
(60) Provisional application No. 62/609,566, filed on Dec. 22, 2017.

(51) Int. Cl. G05B 11/01; G06F 16/22

(52) U.S. Cl. CPC G05B 11/012; H04L 2012/2841; G06F 16/2272

(57) ABSTRACT

An system and a method for hazardous accident remediation in a facility is disclosed. The system retrieves a current task information for a user associated with the user's device. The system monitors status information associated with the current task. Upon the detection of an abrupt event, The system identifies chemical content of an item associated with the current task and a chemical content of an item nearby at the time of the abrupt event. The system identifies a resultant chemical product from the reaction of both the chemical contents. The system transmits hazard information to a server responsive to the resultant chemical product posing a human health hazard. The server selectively operates an environmental control system responsive to the chemical product.

### RELATED APPLICATIONS

This application claims priority to U.S. Provisional Application No. 62/609,566 filed on Dec. 22, 2017, the content of which is hereby incorporated by reference in its entirety.

### BACKGROUND

Detection and response to the accidents in facilities can be slow, inefficient, and dangerous.

### BRIEF DESCRIPTION OF DRAWINGS

Illustrative embodiments are shown by way of example in the accompanying drawings and should not be considered as a limitation of the present disclosure:

FIG. 1 is a block diagram illustrating an environmental response system for hazardous accident detection and remediation in a facility according to an exemplary embodiment.

FIG. 2A is diagram illustrating a graphical user interface for the monitoring accidents in a facility according an exemplary embodiment.

FIG. 2B is diagram illustrating a graphical user interface for the display of relevant information relating to hazardous accidents in a facility according an exemplary embodiment.

FIG. 3 is a diagram illustrating a conditions and activities for detecting hazardous accidents in a facility according to an exemplary embodiment.

FIG. 4 is a flowchart illustrating a process for detecting hazardous accidents according to an exemplary embodiment.

FIG. 5 is a block diagram of an exemplary mobile device that can be utilized to detect accidents in a facility according to an exemplary embodiment.

FIG. 6 is a block diagram illustrating an electronic device for supporting hazardous accident remediation in a facility according to an exemplary embodiment.

### DETAILED DESCRIPTION

Described in detail herein is an environment response system for detecting and identifying accidents in a facility, determining if a chemical reaction is possible based on the accident, and operating environmental control system systems based on whether the chemical reaction poses a human health hazard.

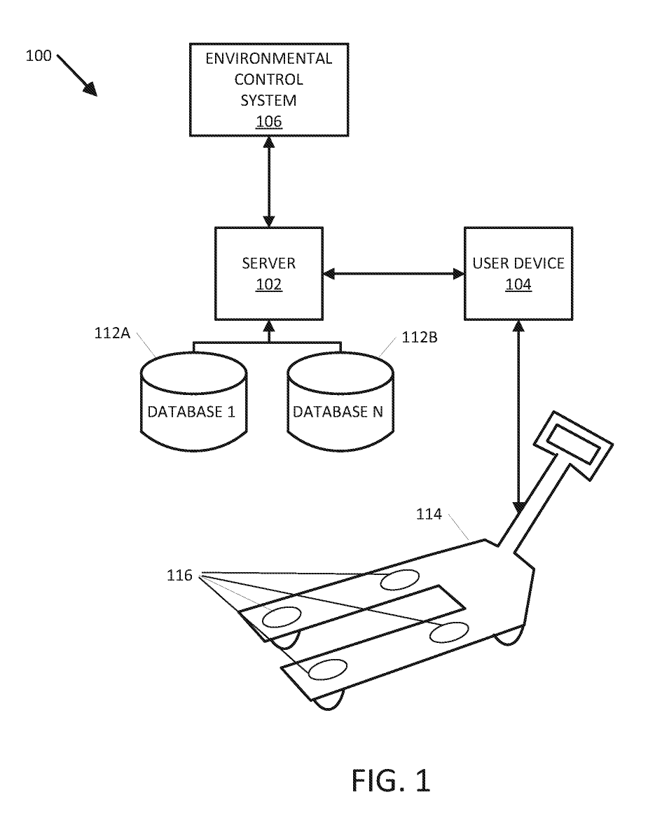

FIG. 1 is a block diagram illustrating an environment response system 100 for hazardous accident detection and remediation in a facility according to an exemplary embodiment. Embodiments of the system 100 can include a server 102, a user device 104, environmental control system 106, databases 112A, 112B, and utility equipment 114.

In one embodiment, the server 102 can be an infrastructure computing systems and resided in a shared computing environment or data center, a stand-alone desktop personal computer, and/or a virtual instance executing in a virtual machine. The server 102 can be configured to provide interfaces to the user device 104, the databases 112A, 112B, and the environmental control system 106. The server 102 can be communicatively connected to the external systems and subsystems in the system 100. The connections can be wireless or wired. Wireless communication can be implemented in standards-based interfaces including WiFi and 4G Long Term Evolution (LTE). Other wireless communication standards can be used in implementation as long as the standards support the higher application layers of the Open Systems Interconnect (OSI) stack necessary to support the purchase management system. Similarly, the server 102 may be connected through wired connections. The wired connections may include any physical medium and underlying OSI stack as to support the higher level application layers to support the purchase management system. The server 102 can include software designed to determine complex chemical interactions based on a list of reactants. The reactants can be household chemicals or catalysts such as incendiary products such as matches. The server 102 executing this software can determine products based on the reactions, as well as determining the hazard the products pose to human health. Additionally, when the reactions include a risk of fire, the software executing on the server 102 indicates a risk of fire.

The user device 104 can be a mobile device, such as a smart phone, smart watch, or tablet-style computing device. Alternatively, the user device 104 can be integrated into the utility equipment 114 utilized by a user in the course of their tasks or activities. Integrated embodiments can be embodied in, for example, pallet jacks and fork lifts. The user device 104 provides the computing platform for receiving input from an array of sensors integrated within the user device or disposed externally and remotely from the user device. As one example, sensors can be disposed on or integrated in the utility equipment 114 or in the environment surrounding the user device 104, and the user device 104 can be configured to communicate with the sensors disposed on or integrated in the utility equipment. The sensors can include but are not limited to accelerometers, gyroscopes, altimeters, weight scales, pressure/force sensors, and thermometers. The array of sensors can be physically integrated into the user device 104. Alternatively, the array of sensors can be logically integrated by the wireless coupling of the array of sensors to the user device 104. Communication support to facilitate communication between the user device 104 and the utility equipment 114 can include Bluetooth®, Zigbee, a near-field communications (NFC) transmitters or other comparable wireless stacks. Additionally, the array of sensors can be implemented within an Internet of Things framework such as ioTivity or Zephyr, which support a development stack with underlying communication application programming interfaces (APIs) already implemented. Additionally, the array of sensors can be selectively powered off based on the current assigned task to save energy of the sensory array, processing power for the reporting device, and bandwidth on the network. The user device 104 can include software designed to determine complex chemical interactions based on a list of reactants. The reactants can be household chemicals or catalysts such as incendiary products such as matches. The user device 104 executing this software can determine products based on the reactions, as well as determining the hazard the products pose to human health. Additionally, when the reactions include a risk of fire, the software executing on the user device 104 indicates a risk of fire. Alternatively, the user device 104 can utilized tables for the determination of chemical products, products that pose a hazard to human health, and catalysts that pose a risk of fire. The tables can be determined based on common products in the facility that pose a risk of reaction. The tables provide a more computationally efficient implementation as a user device 104 can often have limited computational abilities.

The user device 104 can host and/or render a graphical user interface (GUI) for the display, selection, and transmittal of accident pertinent information. For example, the GUI can be displayed on touchscreen and provide responsive feedback after interaction with the user. Alternatively, the GUI can provide voice prompts and can respond to voice commands.

The environmental control system 106 can receive information from the server 102. The environmental control system 106 can include systems configured to render a hazardous situation benign or mitigate the hazard to a level that a human response team can address the root cause. The server 102 can control the environmental control system 106 by the transmission of a digital message in response to a detected accident. The message can include packets containing the location information, condition information, and the action to take. The message can include information limiting the environmental control system 106 response to a certain area of the facility, or alternatively provide a response to the entire facility. The message can include information that can selectively activate or deactivate one or more of the environmental control systems. The environmental control system 106 can include but is not limited to fire suppression systems, ventilation systems, chemical dilution systems, autonomous aerial vehicle surveillance systems, and public address systems.

A fire suppression system can include a computer controlled sprinkler system. In some embodiments, the computer control can assign various valves to zones in order to control the release of water to specific areas rather than the entire facility. Additionally gas extinguishing systems can be utilized to extinguish localized fires. Ventilation systems can include a network of computer controlled fans and ductwork to move large volumes of contaminated air or gases out of the facility. Autonomous aerial vehicle surveillance systems can include multiple programmable unmanned flying vehicles (UAVs) that can be programmed to quickly transit to an accident location, and begin surveilling any damage or activities taking place at the site, providing the operator a remote view of activities and dangers.

The databases 112A, 112B can be internal or external to the server. The databases 112A, 112B can be virtually implemented across a number of computing devices, where the interfaces to access the databases abstracted and are consistent with other database implementations. The databases 112A, 112B contain information relevant to the current task items of the user using the user device 104. The databases 112A, 112B also can contain records of all known chemical contents corresponding to the current task items. The databases 112A, 112B can also contain relational indexes to other tables corresponding to associated attributes to each current task information as well as the respective chemical contents. For example, for a given current task information for warehouse picking, a relational database key for the goods to be picked as well as their chemical contents, can be included in the current task information record. The user device 104 can be configured to index into one or more of the databases 112A, 112B to retrieve the current task information based on the user of the user device 104, the schedule of tasks for the day, and a time of day.

Additionally, the databases 112A, 112B can maintain records for inventory in the facility not associated with the current task information. The inventory records identify the current location in the facility of the inventory as well as a chemical content of the inventory. For reduced computational complexity, the databases 112A, 112B can maintain records on common chemical contents and resultant products of reaction between two or more common chemical contents. The databases 112A, 112B can also include an indication that the resultant product poses a human health risk.

As described herein, the utility equipment 114 can be communicatively coupled with the user device 104. The utility equipment 114 can support wireless communication for an array of onboard sensors. The utility equipment 114 can take the form of any piece of equipment utilized to complete current task information. In a warehouse environment, the utility equipment 114 can take the form of, for example, a pallet jack (as shown) or a fork lift. The utility equipment 114 can host one or more sensor 116. The one or more sensor 116 can host an array of sensors attached to the utility equipment 114 or disposed internally to the sensor. The sensor 116 can provide a coordinated communication point for all the sensors on the utility equipment 114 and can interact with the reporting device 104. The sensor 116 can package data from the sensor array located on the utility equipment 114 and transmit the packaged data to the reporting device 104. The sensors can include but are not limited to accelerometers, gyroscopes, altimeters, weight scales, pressure/force sensors, and thermometers.

In exemplary embodiments, the user device 104 can selectively enable or disable communication with the sensors 116 based on the task for which the utility equipment 114 is being employed. As one example, a task assigned to a user carrying the user device 104 can instruct the user to move a pallet of freight from a specified location to another specified location with a forklift (e.g., utility equipment 114). When the location of the reporting device 104 is determined to be at the specified location, the reporting device 104 can establish a communication channel with the sensor modules on the fork lift to initiate accident detection and monitoring based on sensor data output from the sensor modules 116 of the forklift. The communication channel can remain open as the user performs the task. When the user drives the pallet of freight to the other location, place the freight at the other location (which can be detected by detecting a position of the forks and a weight/force on the forks as detected by the sensor module(s)), the reporting device can terminate the communication channel. For example, a user carrying the user device 104 can be tasked to transport a pallet of bleach to another portion of the distribution center. The user device 104 pairs with the sensors 116 on the utility equipment 114 (e.g. pallet jack) to transport the pallet of bleach. The sensors 116 measure the weight of the pallet of bleach on the utility equipment 114. The sensors 116 provide measurements of the weight in real time to the user device 104. As the utility equipment 114 is utilized in the distribution center, the sensors 116 measure continuously provide measurements to the user device 104. Small variations in the measurements can be discarded due to movement of the utility equipment 114. However, large abrupt changes in measurements, as determined by deltas meeting thresholds, can indicate a possible accident. Once a large abrupt change in measurement has been detected, the user device 104 analyzes the product on the pallet, as well as products in the immediate vicinity of the utility equipment 114 at the time of the abrupt change and does a chemical analysis. In the event that the pallet of bleach collides with a parked pallet of ammonia, the user device 104 determines that a chemical reaction can be taking place. Based on the bleach and ammonia, the user device 104 can determine that the byproduct could be harmful to humans. Based on that determination, the user device 104 can notify the server 104 to activate a ventilation system (e.g., activate fans in the area) to clear the air in that area.

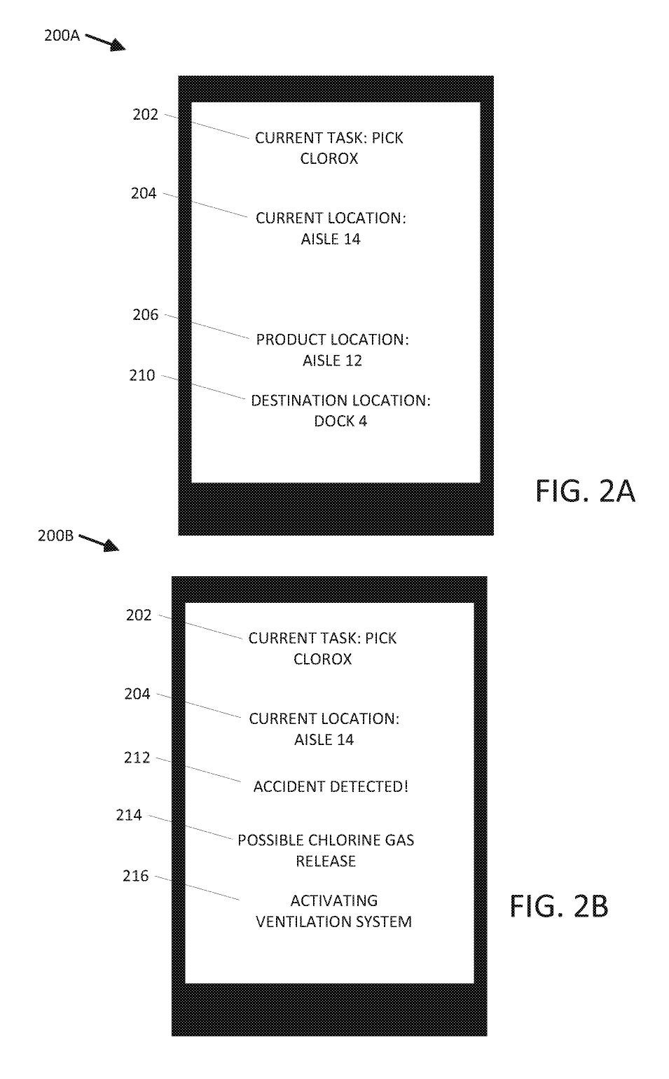

FIG. 2A is diagram illustrating a graphical user interface 200A for the monitoring accidents in a facility according an exemplary embodiment.

The graphical user interface executing on an embodiment of the user device 104 can include an indication of the current task information 202. The current task information 202 can be retrieved from the databases 112A, 112B via requests sent through the server 102. The current task information 202 corresponds to an activity that the user has been scheduled to perform at that particular time. Alternatively, the current task information 202 can be an item processed out of a queue in a serialized order. In another embodiment, the current task information 202 can be selected based on the location of the user and the user device in the facility. The user and the user device 104 can be temporarily located next to the subject of a task item, and the system can assign the current task information 202 based on that proximity.

The graphical user interface can display the user device's current location 204 in the facility. In this embodiment the current location 204 can be a textual representation of the location utilizing labels for portions of the facility to identify location. Alternatively, the graphical user interface can display a map of the facility with a pin indicating the location of the user device 104. The current location 204 can assist a new user in gathering their bearings within the facility to expedite the execution of the current task information 202.

The graphical user interface can display the product location 206 associated with the current task information 202. The product location 206 can be a location within the facility where the product to be addressed in the current task information 202 can be found. In one embodiment, the product location 206 is the location of a product to be picked in a “picking” task. The product location 206 can be a textual description or alternatively can exist on a map as a distinct pin different from a pin indicating the current location 204.

A destination location 210 can also be displayed on the graphical user interface. The destination location 210 can be an optional user interface element only presented when the specified current task information 202 calls for it. In one embodiment, the destination location 210 corresponds to a location to relocate a product within the facility. The destination location 208 can be a textual description or alternatively can exist on a map as a distinct pin different from a pin indicating the current location 204 or the product location 206.

FIG. 2B is diagram illustrating a graphical user interface 200B for the display of relevant information relating to hazardous accidents in a facility according an exemplary embodiment. The graphical user interface can contain graphical elements corresponding to the current task information 202, and the current location 204.

Additionally, once the user device 104 has determined that an accident has occurred, the user device 102 can present an accident notification 212 element. The accident notification 212 can be a text field with a description of the detected accident. Alternatively, the accident notification 212 can be a graphical element displayed on a map of the facility, where the accident notification is distinct from the current location 204, the product location 206, and the destination location 210, where the map element persists on both map user interfaces 200A, 200B. In one embodiment, the determination of an accident can be determined on the server 102 and propagated through a network connection to the user device 104 to be displayed as the accident notification 212 element.

On the graphical user interface 200B, the hazard information 214 can be displayed as well to alert the user of the user device 104 of the type of hazard detected. The hazard information 214 can be a textual description of the determined hazard. In one embodiment, the hazard information 214 can indicate the release or creation of toxic gasses. In another embodiment, the hazard information 214 can indicate the potential for fire due to the creation of combustible materials.

The graphical user interface 200B can also present remediation information 216. In one embodiment, the remediation information 216 can be a textual description of the environmental control system 106 system tasked with responding. Additionally, the remediation information 216 can describe the scope of the remedy for the hazard. The remediation information 216 can also instruct the user of the user device 104 to take an action. In one embodiment, the remediation information 216 can indicate a toxic gas has been created and the user to promptly exit the building.

The accident notification 212 element, the hazard information 214, and the remediation information 216 can be implemented across all user devices operating in the facility. The instantiation of the respective elements can be implemented as a push notification to all user devices 106 in a facility to provide warnings to other users in the event of a hazardous event. The system can limit the push notifications based on the severity of the accident, where the severity determined by a series of thresholds. For example a single threshold system for push notifications can broadcast notifications for any hazards that posed a risk to human health, while accidents that are determine to be non-hazardous are not broadcast.

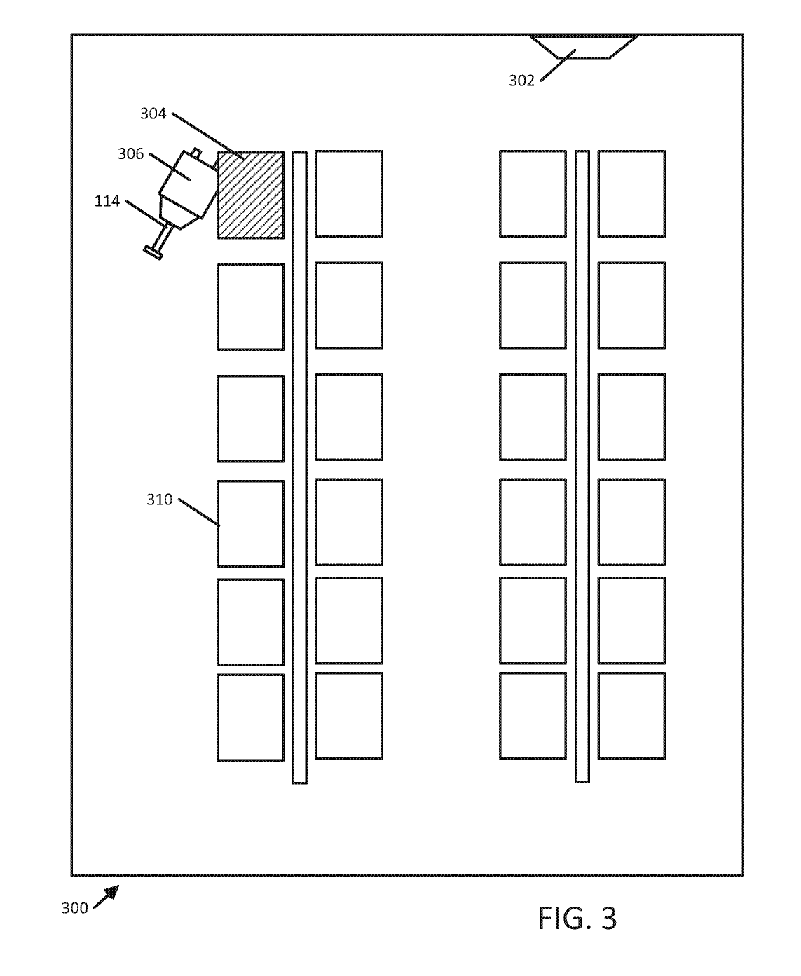

FIG. 3 is a diagram illustrating conditions and activities for detecting hazardous accidents in a facility 300 according to an exemplary embodiment.

The current task information, as exemplified in FIG. 3, is a picking operation. The user of the user device 104 can be requested to locate, select, and transport a certain product to another location within the facility. The diagram 300 illustrates a point in time during the performance of current task that correspond to an occurrence of an accident.

The current task information requests transporting product 306 from a product location 310 in the facility to be transported to a destination location 302. In transit, a collision, as shown in FIG. 3, occurs between the utility equipment 114, an inventory product 304, and the transporting product 306.

The user device 104, through the sensors 116 in the user device and/or on the utility equipment 114, detects the impact. The sensors 116 provide raw data corresponding to the activity taking place when the current task is being performed. The form of the raw data is determined by the type of sensor 116 providing it. For example, a weight sensor provides raw data in pounds of kilograms, indicating the weight of the object on top of the sensor. The user device 104 determines location information relating to the position of the device within the facility. The user device 104 transmits a confirmation of the current task information as well as the location information to the server 102. Upon receipt, the server 102 retrieves records pertaining to inventory product 304 located within a threshold area to the location information from the databases 112A, 112B. Upon a successful retrieval, the server 102 can retrieve product information corresponding to the current task information.

The server 102 evaluates any chemical component corresponding to the inventory product 304 and any chemical component corresponding to the transporting product 306. A server 102 can perform a chemical reaction model based on the corresponding chemical components of the inventory product 304 and the transporting product 306 acting as reagents. Based on that model, if any products of a reaction between the reagents happen to pose a human health hazard, the server 102 notifies the environmental control system 106. The chemical reaction modelling can be provided by third party software designed to execute on the server 102. The modelling software can accept reagents as inputs and products as outputs. The databases 112A, 112B, can include identified products known to pose human health risks.

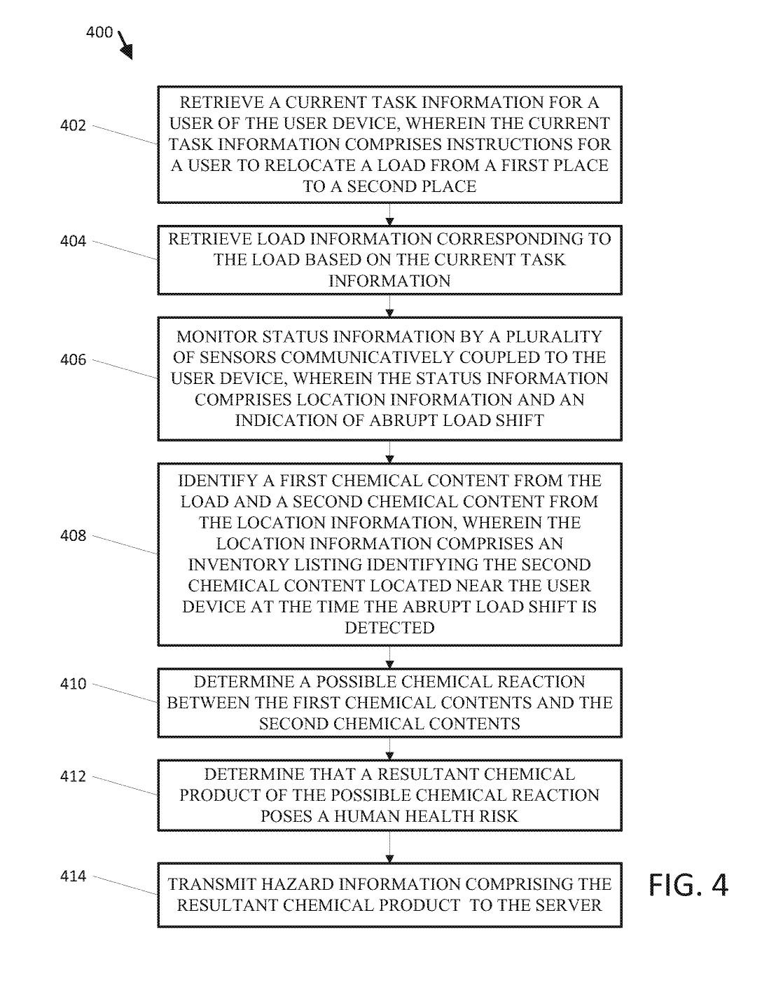

FIG. 4 is a flowchart illustrating a process 400 for detecting hazardous accidents according to an exemplary embodiment. For more efficient use of system resources, some of the steps of the process can be executed on the user device 104 or on the server 102 during periods of computational load or network saturation.

At step 402, the user device 104 or server 102 retrieves current task information for a user of the user device. For example, the current task information comprises instructions for a user to relocate a load from a first place to a second place. The current task information can be series of records in the databases 112A, 112B, identifying the user of the user device 104, and a schedule of tasks for the day, as well as the time of day. The user can works through each task information activity through out the work day.

At step 404, the user device 104 or server 102 retrieves load information corresponding to the load based on the current task information. The server 102 can utilize a database reference included in the current task information to index into the databases 112A, 112B to retrieve load information for the current task information.

At step 406, the user device 104 monitors status information by a plurality of sensors communicatively coupled to the user device. The status information can be location information of the user and the user device 104. In some instances, a sudden or rapid change in the output (a data stream) of one or more sensors can be detected by the user device and can be an indication of abrupt load shift. For example, rapid changes in accelerometer output, the weigh sensor output, the gyroscope, and/or the pressure/force sensor can be an indication of abrupt load shift. A change in weight detected by one or more weight sensors or pressure/force sensors at different points on a pallet jack or forklift can be an indication of abrupt load shift. Additionally, or in the alternative, detection of an abrupt load shift corresponding to a potential accident can require a combination of rapid changes in the contents of the data streams from one, two, or several of the sensors.

At step 408, the user device 104 or server 102 identifies a first chemical content from the load and a second chemical content from the location information. The location information can be an inventory listing identifying the second chemical content located near the user device at the time the abrupt load shift is detected. For example, the first chemical content can be acetic acid (CH₃COOH) or vinegar loaded on a pallet jack and the second chemical content can be bleach (NaClO) stored on a pallet on the facility floor. In one embodiment, the server 102 provides the processing resources to identify the chemical contents.

At step 410, the user device 104 or server 102 determines a possible chemical reaction between the first chemical contents and the second chemical contents. A third party software package can perform the chemical reaction modelling based on the first chemical content and the second chemical content. The software package can accept chemical contents as reagents or inputs and produce outputs consisting of products of any reaction that may occur. From the example above, bleach reacting with vinegar can produce chlorine gas (Cl₂) as a product. Similar to step 408, the server 102 can provide the processing resources to determine the possible chemical reaction.

At step 412, the user device 104 or server determines that a resultant chemical product of the possible chemical reaction poses a human health risk. The resultant chemical product can be looked up in a table in the databases 112A, 112B to determine if the product poses a human health risk. To eliminate computational complexity, the chemical product database can be limited to possible chemical products based on inventory in the facility.

At step 414, the user device 104 transmits hazard information comprising the resultant chemical product to the server 102, which can generate and transmits alerts to other user device in the area. The user device 104 can be configured to transmit hazard information comprising the resultant chemical product, directly or indirectly, to other user devices in the area. In another embodiment the hazard information can be relayed to a relevant third party system for remediation. The server can selectively activate or deactivate environmental control system systems based on the hazard information. For example, if the hazard information indicates toxic fumes in the area, the server can activate a ventilation system (e.g., activate one or more fans to vent the fumes from the area). Responsive to hazard information indicating fire, the server can activate a fire suppression system.

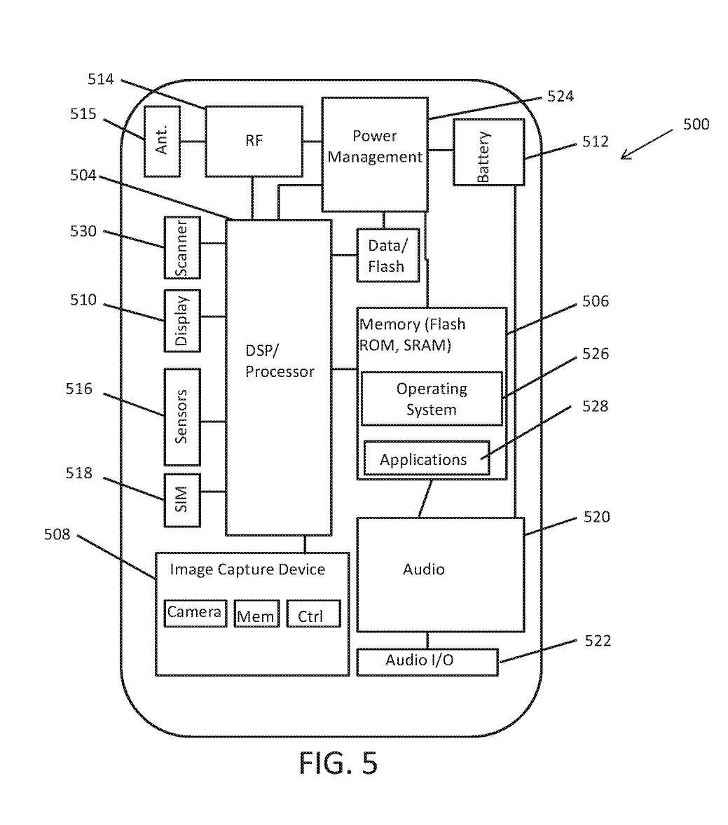

FIG. 5 is a block diagram of an exemplary mobile device for supporting accident detection monitoring, and remediation in a facility according to an exemplary embodiment. The mobile device 500 can be a smartphone, tablet, subnotebook, laptop, personal digital assistant (PDA), handheld device, such as a Symbol® MC18 and/or any other suitable mobile device that can be programmed and/or configured to implement and/or interact with embodiments of the system via wireless communication. For example, the mobile device 500 can be a Symbol® MC18. Symbol® MC18 can be a handheld mobile computer configured to execute the Android and/or Windows operating system. The Symbol® MC18 can include 1D and 2D Scanner, Wi-Fi (802.11a/b/g/n), Camera, VGA Display, Android 2.3 and/or Windows 7, 1 GB RAM/8 GB Flash, Standard Battery.

The mobile device 500 can include a processing device 504, such as a digital signal processor (DSP) or microprocessor, memory/storage 506 in the form a non-transitory computer-readable medium, an image capture device 508, a touch-sensitive display 510, a power source 512, a radio frequency transceiver 514 and a reader 530. Some embodiments of the mobile device 500 can also include other common components commonly, such as sensors 516, subscriber identity module (SIM) card 518, audio input/output components 520 and 522 (including e.g., one or more microphones and one or more speakers), and power management circuitry 524. The sensors 516 can include a location-based sensor 534, configured to determine the location of the mobile device 500.

The memory 506 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 526 and applications 528 can be embodied as computer-readable/executable program code stored on the non-transitory computer-readable memory 506 and implemented using any suitable, high or low level computing language and/or platform, such as, e.g., Java, C, C++, C#, assembly code, machine readable language, and the like. In some embodiments, the applications 528 can include a facility application configured to interact with the microphone, a web browser application, a mobile application specifically coded to interface with one or more servers of embodiments of the system for data transfer in a distributed environment. While memory is depicted as a single component those skilled in the art will recognize that the memory can be formed from multiple components and that separate non-volatile and volatile memory devices can be used.

The processing device 504 can include any suitable single- or multiple-core microprocessor of any suitable architecture that is capable of implementing and/or facilitating an operation of the mobile device 500. For example, a user can use the mobile device 500 in a facility to perform an image capture operation, capture a voice input of the user (e.g., via the microphone), transmit messages including a captured image and/or a voice input and receive messages from another computing system, display data/information including GUIs of the user interface 510, captured images, voice input transcribed as text, and the like. The mobile device 500 can perform the aforementioned operations on an internet browser executing on the mobile device, or any web-based application. The processing device 504 can be programmed and/or configured to execute the operating system 526 and applications 528 to implement one or more processes and/or perform one or more operations. The processing device 504 can retrieve information/data from and store information/data to the storage device 506.

The RF transceiver 514 can be configured to transmit and/or receive wireless transmissions via an antenna 515. For example, the RF transceiver 514 can be configured to transmit data/information, such as input based on user interaction with the mobile device 500. The RF transceiver 514 can be configured to transmit and/or receive data/information having at a specified frequency and/or according to a specified sequence and/or packet arrangement.

The touch-sensitive display 510 can render user interfaces, such as graphical user interfaces to a user and in some embodiments can provide a mechanism that allows the user to interact with the GUIs. For example, a user may interact with the mobile device 500 through touch-sensitive display 510, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 512 can be implemented as a battery or capacitive elements configured to store an electric charge and power the mobile device 500. In exemplary embodiments, the power source 512 can be a rechargeable power source, such as a battery or one or more capacitive elements configured to be recharged via a connection to an external power supply. The scanner 530 can be implemented as an optical reader configured to scan and decode machine-readable elements disposed on objects.

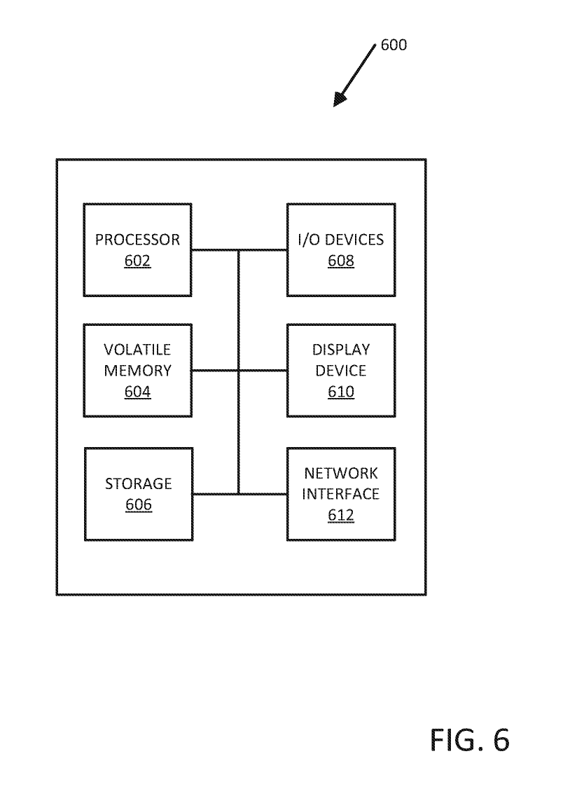

FIG. 6 is a block diagram illustrating a computing device 600 for supporting accident detection monitoring, and remediation in a facility according to an exemplary embodiment.

The computing device 600 can embody the server 102 and/or the user device 104. The computing device 600 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 604 included in the computing device 600 can store computer-readable and computer-executable instructions or software for implementing exemplary operations of the computing device 600. The computing device 600 also includes configurable and/or programmable processor 602 for executing computer-readable and computer-executable instructions or software stored in the volatile memory 604 and other programs for implementing exemplary embodiments of the present disclosure. Processor 602 can be a single core processor or a multiple core processor. Processor 602 can be configured to execute one or more of the instructions described in connection with computing device 600.

Volatile memory 604 can include a computer system memory or random access memory, such as DRAM, SRAM, EDO RAM, and the like. Volatile memory 604 can include other types of memory as well, or combinations thereof.

A user can interact with the computing device 600 through a display 610, such as a computer monitor, which can display one or more graphical user interfaces supplemented by I/O devices 608, which can include a multi-touch interface, a pointing device, an image capturing device and a reader.

The computing device 600 can also include storage 606, such as a hard-drive, CD-ROM, or other computer-readable media, for storing data and computer-readable instructions and/or software that implement exemplary embodiments of the present disclosure (e.g., applications). For example, storage 606 can include one or more storage mechanisms for storing information associated with detecting hazardous accidents which details relating to accidents can be indexed accordingly. The storage mechanism can be updated manually or automatically at any suitable time to add, delete, and/or update one or more data items in the databases 112A, 112B when attached.

The computing device 600 can include a network interface 612 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 612 can include one or more antennas to facilitate wireless communication between the computing device 600 and a network and/or between the computing device 600 and other computing devices. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step. Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. An environmental response system for the remediation of hazardous conditions in a warehouse, the system comprising:
a server communicatively coupled to environmental control system systems;
a user device communicatively coupled to the server, the user device being configured to:
retrieve a current task information for a user of the user device, wherein the current task information comprises instructions for a user to relocate a load from a first place to a second place;
retrieve load information corresponding to the load based on the current task information;
monitor status information by a plurality of sensors communicatively coupled to the user device, wherein the status information comprises location information and an indication of abrupt load shift;
identify a first chemical content from the load and a second chemical content from the location information, wherein the location information comprises an inventory listing identifying the second chemical content located near the user device at the time the abrupt load shift is detected;
determine a possible chemical reaction between the first chemical contents and the second chemical contents;
determine that a resultant chemical product of the possible chemical reaction poses a human health risk; and
transmit hazard information comprising the resultant chemical product to the server,
wherein the server controls one or more of the environmental control system systems to mitigate an affect of the resultant chemical product.

2. The system of claim 1, wherein the server is configured to transmit the hazard information to a relevant third party system for remediation.

3. The system of claim 1, wherein the server is configured to selectively activate or deactivate the one or more of the environmental control system systems responsive to hazard information.

4. The system of claim 3, wherein at least one of the environmental control system systems comprises a ventilation system, a fire suppression system, or an autonomous aerial vehicle surveillance system.

5. The system of claim 1, wherein the user device is configured to:
index into a database comprising a plurality of task information based, at least in part, on an identity associated with the user of the user device, a schedule of tasks for a day, and a time of day.

6. The system of claim 1, wherein at least one of the plurality of sensors comprises an accelerometer, a thermometer, a gyroscope, or a weight scale.

7. The system of claim 6, wherein an indication of abrupt load shift comprises a rapid change in contents of a data stream from one or more of the plurality of sensors to the user device.

8. A method for the remediation of hazardous conditions in a warehouse comprising:
retrieving a current task information for a user of a user device, wherein the current task information comprises instructions for a user to relocate a load from a first place to a second place;
retrieving load information corresponding to the load based on the current task information;
monitoring status information by a plurality of sensors communicatively coupled to the user device, wherein the status information comprises location information and an indication of abrupt load shift;
identifying a first chemical content from the load and a second chemical content from the location information, wherein the location information comprises an inventory listing identifying the second chemical content located near the user device at the time the abrupt load shift is detected;
determining a possible chemical reaction between the first chemical contents and the second chemical contents;
determining that a resultant chemical product of the possible chemical reaction poses a human health risk; and
transmitting hazard information comprising the resultant chemical product to a server,
wherein the server controls one or more environmental control system systems to mitigate an affect of the resultant chemical product.

9. The method of claim 8, wherein the server is configured to transmit the hazard information to a relevant third party system for remediation.

10. The method of claim 8, wherein the server is configured to selectively activate or deactivate the one or more of the environmental control system systems responsive to hazard information.

11. The method of claim 10, wherein at least one of the environmental control system systems comprises a ventilation system, a fire suppression system, or an autonomous aerial vehicle surveillance system.

12. The method of claim 8, wherein retrieving the load information comprises indexing into a database comprising a plurality of task information, based, at least in part on an identity associated with the user of the user device, a schedule of tasks for a day, and a time of day.

13. The method of claim 8, wherein the at least one of the plurality of sensors comprises an accelerometer, a thermometer, a gyroscope, or a weight scale.

14. The method of claim 8, wherein an indication of abrupt load shift comprises a rapid change in contents of a data stream from one or more of the plurality of sensors to the user device.

15. A non-transitory computer readable medium, having stored thereon, instructions that when executed by a computing system, cause the computing system to perform operations comprising:
retrieve a current task information for a user of a user device, wherein the current task information comprises instructions for a user to relocate a load from a first place to a second place;
retrieve load information corresponding to the load based on the current task information;
monitor status information by a plurality of sensors communicatively coupled to the user device, wherein the status information comprises location information and an indication of abrupt load shift;
identify a first chemical content from the load and a second chemical content from the location information, wherein the location information comprises an inventory listing identifying the second chemical contents located near the user device at the time the abrupt load shift is detected;
determine a possible chemical reaction between the first chemical contents and the second chemical contents; and
determine that a resultant chemical product of the possible chemical reaction poses a human health risk;
transmit hazard information comprising the resultant chemical product to a server,
wherein the server controls one or more environmental control system systems to mitigate an affect of the resultant chemical product.

16. The non-transitory computer readable medium of claim 15, wherein the instructions further comprise operations to transmit the hazard information to a relevant third party system for remediation.

17. The non-transitory computer readable medium of claim 15, wherein the instructions further comprise operations to selectively activate or deactivate the one or more of the environmental control system systems responsive to hazard information.

18. The non-transitory computer readable medium of claim 17, wherein at least one of the environmental control system systems comprises a ventilation system, a fire suppression system, or an autonomous aerial vehicle surveillance system.

19. The non-transitory computer readable medium of claim 15, wherein the operations for retrieving the load information comprise indexing into a database comprising a plurality of task information, based, at least in part on an identity associated with the user of the user device, a schedule of tasks for a day, and a time of day.

20. The non-transitory computer readable medium of claim 15, wherein an indication of abrupt load shift comprises a rapid change in contents of a data stream from one or more of the plurality of sensors to the user device.
